(19) United States
(12) Patent Application Publication
(10) Pub. No.: US 2013/0029136 A1
(43) Pub. Date: Jan. 31, 2013

(54) Transparent Polycarbonate Elements with Alumina Coatings

(71) Applicant: Markus D. Groner, Louisville, CO (US)

(72) Inventor: Markus D. Groner, Louisville, CO (US)

(21) Appl. No.: 13/191,515

(22) Filed: Jul. 27, 2011

(51) Int. Cl. B32B 27/36

(52) U.S. Cl. 428/336

(57) ABSTRACT

Polycarbonate elements are coated with an ultrathin alumina coating. These elements are highly resistant to yellowing when exposed to electromagnetic radiation of about 25 to 700 nm in wavelength. Accordingly, the coated polycarbonate elements are useful component of a wide variety of devices, such as aircraft, vehicles, optical devices and LED devices.

This invention relates to transparent polycarbonate devices having an ultra-thin alumina coating.

Polycarbonates are often used as substitutes for glass in applications where transparency, high strength and resistance to shattering is needed. A problem with polycarbonates is that they are not stable to sunlight, certain types of artificial light and UV light. Exposure to these light sources degrades the polycarbonates. The degradation results in yellowing. Because of this problem, polycarbonates are often formulated with stabilizers of various types to try to inhibit this yellowing.

However, these approaches are often inadequate, especially in applications which as LED lenses or windows, in which very high transparency is needed over a wide range of wavelengths, and in applications in which the polycarbonate is exposed to high levels of ultraviolet radiation. Aerospace vehicle windows and canopies are examples of the latter applications. Therefore, it is desirable to provide devices that consist of or comprise a transparent polycarbonate element, wherein the transparent polycarbonate element is resistant to yellowing upon exposure to sunlight, artificial light and/or ultraviolet light.

This invention is a device comprising a transparent polycarbonate element, wherein the transparent polycarbonate element is coated on at least one surface with a continuous alumina film having a thickness of up to 200 nm.

Applicants have unexpectedly found that the presence of the continuous alumina film imparts very significant stability to light to the polycarbonate element. The alumina coating has essentially no effect on the transmission of visible light through the polycarbonate element, and so the element remains highly transparent despite the presence of the coating. The light stability imparted by the alumina coating makes polycarbonate element very resistant to yellowing. This effect is unexpected and surprising, because alumina is not known to function as a UV absorber and thus an alumina layer, especially an extremely thin, transparent alumina layer, would not be expected to have any beneficial effect in preventing yellowing in a polycarbonate resin.

The stability to light provided by the continuous alumina film may in some instances also reduce the loss of mechanical properties (in particular the tendency of the polycarbonate to become brittle) upon exposure to light.

The resistance to yellowing in polycarbonate sheets coated with such very thin layers of alumina makes them useful and desirable in devices in which the properties of non-yellowing and transparency are important and must be maintained even upon long-term exposure to ultraviolet light.

Examples of such devices include, for example, jet fighter canopies; aircraft windows; helicopter canopies and windows; protective windows, barriers and doors, such as, for example, for use in police and/or military installations, jails and prisons, hospitals and other institutions; protective shields, such as for police and/or military personnel; lenses and windows in optical devices such as, for example, eyeglass lenses, camera lenses, microscope and/or telescope lenses, LED (light-emitting diode) lenses and windows; diffusers, protective and/or decorative covers and bulb materials for artificial lighting, including, for example, automotive headlights, highway and/or parking lot lighting, and the like.

Therefore, in various specific embodiments, the device of this invention is:
a. An aircraft, such as, for example, a jet fighter or helicopter, having a transparent polycarbonate canopy;
b. An aircraft having a transparent polycarbonate window;
c. A transparent polycarbonate protective window, barrier or door;
d. A protective shield comprising a transparent polycarbonate sheet;
e. An optical device, such as eyeglasses, a camera, a microscope and/or a telescope, having a transparent polycarbonate lens or window;
g. An LED lens comprising a transparent polycarbonate lens or window;
h. A diffuser, or protective cover or bulb material for artificial lighting, the diffuser, protective cover or bulb material comprising a transparent polycarbonate element; or
i. a visor or other eye protection device;
   in each case the polycarbonate having an alumina coating of up to 200 nm in thickness on at least one surface, in accordance with the invention.

The benefit of the alumina coating is best seen when the continuous alumina film is present on at least one surface of the transparent polycarbonate element that, during use, is exposed to the atmosphere. More preferably, the continuous alumina coating is present on all surfaces of the transparent polycarbonate element that, during use, are exposed to the atmosphere.

The alumina coating is preferably at least 2 nm thick, and more preferably at least 5 nm thick or at least 10 nm thick. The benefits of this invention are often seen when the alumina coating is no greater than 50 nm thick or no greater than about 35 nm thick. An especially preferred coating is from 15 to 35 nm thick.

The polycarbonate is an organic polymer having a carbonate linkages and a melt flow rate, as measured according to ASTM D128 at 300° C./1.2 kg of from 1 to 150, preferably from 1 to 100 g/10 minutes. It is preferably thermoplastic. The polycarbonate preferably is an aromatic polycarbonate, such as one corresponding to a reaction product of a bisphenol with a polycarbonate precursor such as phosgene or a dialkyl carbonate. The polycarbonate preferably has a visible light transmittance of at least 85%, as measured according to ASTM D1003, a haze value per ASTM D1003 of no greater than 1.5 and preferably no greater than 1.2, and a refractive index of from 1.5 to 1.65. Examples of suitable aromatic polycarbonates include those sold by LG-Dow Polycarbonates under the Calibre™ trade name, those sold by Bayer under the Markolon™ tradename and those sold by GE under the Lexan™ tradename.

In this invention, the polycarbonate is generally fabricated into the form of the particular element as is to be incorporated into a device, and the alumina coating is then applied to at least one surface of the fabricated element. The element can be fabricated from the polycarbonate using a wide variety of techniques, including various melt processing and machining methods. The element is formed into a shape and dimensions as is indicated by its intended use in the device.

The alumina coating can be deposited onto the surface of the polycarbonate element using an atomic layer deposition (“ALD”; also known as ALE—“atomic layer epitaxy”). ALD techniques permit in each reaction cycle the formation of alumina layers approximately equal to the molecular spacing of the inorganic material, typically up to about 0.3 nm of thickness per reaction cycle. In the ALD process, alumina can be formed in a series of two self-limited reactions, which in most instances can be repeated to sequentially form additional material until the alumina layer reaches the desired thickness.

Methods of applying an alumina layer onto a polymeric substrate are described, for example, in WO 03/08110 and US Published Patent Application No. 2004-0194691.

It is possible if desired to perform a precursor reaction at the surface of polycarbonate to introduce functional groups onto its surface before applying the alumina coating. Depending on the particular polymer, techniques such as water plasma treatment, ozone treatment, ammonia treatment and hydrogen treatment are among the useful methods of introducing functional groups.

The polycarbonate element may be treated before initiating the reaction sequence to remove volatile materials that may be absorbed onto the surface. This is readily done by exposing the substrate to elevated temperatures and/or vacuum. The polymer substrate is then sequentially contacted with gaseous reactants.

The alumina layer is deposited at a temperature below that at which the polycarbonate element degrades, melts, or softens enough to lose its physical shape. The polycarbonate element is generally held in a chamber that can be evacuated to low pressures. Each reactant is introduced sequentially into the reaction zone, typically together with an inert carrier gas. Before the next reactant is introduced, the reaction by-products and unreacted reagents are removed. This can be done, for example, by subjecting the element to a high vacuum, such as about 10⁻⁵ torr or lower, after each reaction step. Another method of accomplishing this, which is more readily applicable for industrial application, is to sweep the element with an inert purge gas between the reaction steps. This purge gas can also act as a carrier for the reagents. The next reactant is then introduced, where it reacts at the surface of the element. After removing excess reagents and reaction by-products, as before, the reaction sequence can be repeated as needed to build alumina films of the desired thickness.

A useful ALD process for producing alumina films involves a reaction between trimethylaluminum (TMA) and water, which produce alumina according to the general idealized reaction 2Al(CH₃)₃+3H₂O——>Al₂O₃+6CH₄. In the ALD process, this reaction is conducted as half-reactions as follows (following initial introduction of TMA onto the polymer surface):

Al—(CH₃)*+H₂O→Al—OH*+CH₄ (A1)

Al—OH*+Al(CH₃)₃→Al—O—Al(CH₃)₂*+CH₄ (B1)

The asterisk (*)indicates a species at the surface of the inorganic material. This particular sequence of reactions to deposit alumina is particularly preferred, as the reactions can proceed at temperature below 350 K. This particular reaction sequence tends to deposit Al₂O₃ at a rate of ˜1.2 Å per AB cycle. On polycarbonate substrates, a somewhat greater rate of growth is sometimes seen, especially during the first 25-50 AB reaction cycles. Triethyl aluminum (TEA), aluminum ethoxide, aluminum trichloride and the like can also be used in place of TMA in the reaction sequence. Ozone, oxygen, hydrogen peroxide and oxygen plasma can be used in place of water in this reaction sequence.

It may be desirable to deposit a precursor layer onto the polycarbonate element before depositing the alumina layer but this is generally not necessary.

Several techniques are useful for monitoring the progress of the ALD reactions. For example, vibrational spectroscopic studies can be performed on high surface area silica powders using transmission Fourier transform infrared techniques. The deposited coatings can be examined using in situ spectroscopic ellipsometry. Atomic force microscopy studies can be used to characterize the roughness of the coating relative to that of the surface of the substrate. X-ray photoelectron spectroscopy and x-ray diffraction can by used to do depth-profiling and ascertain the crystallographic structure of the coating.

The deposited alumina forms a continuous film over at least one surface, and preferably all exposed surfaces of the polycarbonate element. The film is preferably conformal. By “conformal” it is meant that the thickness of the coating is relatively uniform across the surface of the particle (so that, for example, the thickest regions of the coating are no greater than 3×, preferably no greater than 1.5× the thickness of the thinnest regions), so that the surface shape of the coated substrate closely resembles that of the underlying substrate surface. Conformality is determined by methods such as transmission electron spectroscopy (TEM) that have resolution of 10 nm or below. Lower resolution techniques cannot distinguish conformal from non-conformal coatings at this scale. The desired substrate surface is also preferably coated substantially without pinholes or defects.

The alumina-coated polycarbonate element is transparent, by which it is meant that it has a light transmission (visible light) of at least 75%, more preferably at least 85%, as measured according to ASTM D1008. The alumina-coated polycarbonate element may be colorless or nearly so, or may be tinted if some coloration is needed or desirable for a specific application.

A protective layer or film may be applied to the top of the alumina coating of the polycarbonate element to protect the alumina coating from mechanical, thermal or chemical damage.

The alumina-coated polycarbonate element is in general used in the same manner as conventional polycarbonate elements are used in the various devices. In some cases, the polycarbonate element may constitute the device, whereas in others, the polycarbonate element forms only one or more components of a larger assembly. The general design (shape, dimensions) of the polycarbonate element is in general the same as in conventional devices, apart from the presence of the alumina layer. The benefits of this invention are best seen when the polycarbonate element is positioned such that surfaces that are exposed to electromagnetic radiation in the wavelength range of about 25 to 700 nm (such as sunlight, artificial light and/or ultraviolet light) during use are coated with the alumina coating, and/or surfaces of the polycarbonate element that during use come into contact with a source of oxygen (such as air, molecular oxygen, atomic oxygen, ozone or other forms) or other strong oxidant are covered with the alumina coating.

LED lens applications are of particular interest. The LED device may be, for example, used for artificial lighting, such as for home, industrial, office, institutional and/or vehicular use. Automotive LED lights are an important application. Alternatively, the LED device may be all or part of a display, signaling device, communication device, analytical device, and the like. The polycarbonate LED lens may be focusing or non-focusing; may be diffusing, and/or may be prismatic.

Similarly, the polycarbonate element of other optical devices may be a focusing or non-focusing lens or window, a diffusing lens or window, or a prismatic lens or window.

The following example is provided to illustrate the invention, and is not intended to limit the scope thereof. All parts and percentages are by weight unless otherwise indicated.

### EXAMPLE

A continuous alumina coating is applied by atomic layer deposition to a 4″×4″ sheet of a bisphenol-A type polycarbonate (Bayer Makrolon™ AR) having a thickness of about 6 mm (¼ inch). This polycarbonate sheet, prior to applying the alumina coating, is coated on each side with a hard UV protective coating. The precursors are trimethyl aluminum and water. 200 reaction cycles are performed at 95° C. to deposit an alumina coating approximately 25 nm thick on one planar surface of the polycarbonate sheet. To the naked eye, the resulting alumina-coated polycarbonate sheet appears equally transparent as the uncoated starting material.

The coated polycarbonate sheet is exposed in air to 593 hours of solar radiation using a Spectrosun™ X25 Solar Simulator (Spectrolab Inc.). For comparison, an uncoated sample of the Bayer Makrolon AR sheet is similarly exposed.

The uncoated polycarbonate sheet visibly yellows on this test. The alumina-coated polycarbonate sheet, on the other hand, shows no yellowing that is visible to the naked eye. An absorbance spectrum of the alumina-coated polycarbonate sheet is taken across the wavelength range of 375 to 2000 nm. A similar spectrum of an uncoated sample of the Makrolon AR polycarbonate sheet also is taken. % Transmission for the two samples are very similar across the entire range of wavelengths, except the uncoated polycarbonate sheet is seen to absorb more light in the ˜425 nm region, which is consistent with the yellow color of that sample as seen by the naked eye. The spectra further demonstrate that the presence of the 25 nm alumina coating has essentially no effect on the transparency of the polycarbonate.

1. A device comprising a transparent polycarbonate element, wherein the transparent polycarbonate element is coated on at least one surface with a continuous alumina film having a thickness of up to 200 nm.

2. The device of claim 1 which is an aircraft, and the transparent polycarbonate element is a canopy.

3. The device of claim 1 which is an aircraft, and the transparent polycarbonate element is a window.

4. The device of claim 1 wherein the transparent polycarbonate element is a protective window, barrier or door.

5. The device of claim 1 which is a protective shield.

6. The device of claim 1 which is an optical device, and the transparent polycarbonate element is a lens or window.

7. The device of claim 6, wherein the optical device is an eyeglass, and the transparent polycarbonate element is a focusing lens.

8. The device of claim 6, wherein the optical device is a camera, and the transparent polycarbonate element is a focusing lens.

9. The device of claim 6, wherein the optical device is a microscope or telescope, and the transparent polycarbonate sheet is a focusing lens.

10. The device of claim 1 which is an LED, and the transparent polycarbonate element is a lens or window.

11. The device of claim 10, wherein the LED is an automotive light.

12. The device of claim 1, wherein the device is an artificial lighting device and the transparent polycarbonate element is a lens, diffuser, protective cover or bulb material.

13. The device of claim 1, wherein the alumina coating is from 5 to 50 nm thick.

14. The device of claim 13, wherein the alumina coating is from 15 to 35 nm thick.

15. The device of claim 1, wherein the polycarbonate is an aromatic polycarbonate.

16. The device of claim 15, wherein the aromatic polycarbonate has a melt flow rate, as measured according to ASTM D128 at 300° C./1.2 kg, of from 1 to 100 g/10 minutes.

17. The device of claim 16, wherein the polycarbonate has a visible light transmittance of at least 85%, as measured according to ASTM D1003, a haze value per ASTM D1003 of no greater than 1.2, and a refractive index of from 1.5 to 1.65.
